(19) United States
(12) Patent Application Publication
(10) Pub. No.: US 2024/0351690 A1
(43) Pub. Date: Oct. 24, 2024

(54) LOUNGE SYSTEM FOR AN INTERNAL CABIN OF AN AIRCRAFT

(71) Applicant: THE BOEING COMPANY, Arlington, VA (US)

(72) Inventors: Tom Eaton, Los Angeles, CA (US); Victor Carlioz, Los Angeles, CA (US); Matthew Cleary, Los Angeles, CA (US); Andrew Greenbaum, Los Angeles, CA (US); Claire Nelsen, Los Angeles, CA (US)

(73) Assignee: THE BOEING COMPANY, Arlington, VA (US)

(21) Appl. No.: 18/436,270

(22) Filed: Feb. 8, 2024

Related U.S. Application Data
(60) Provisional application No. 63/497,246, filed on Apr. 20, 2023.

(51) Int. Cl. B64D 11/06; B64D 11/00

(52) U.S. Cl. CPC B64D 11/0601; B64D 11/0015; B64D 11/003

(57) ABSTRACT

A lounge system for an internal cabin of an aircraft includes a compartment bounded by a wall common to a monument, an interior outboard wall of the internal cabin, one or more side partition walls, and one or more end partition walls. One or more seats are within the compartment. One or more desks are within the compartment. One or more screens are within the compartment. An egress area is also within the compartment.

### CROSS-REFERENCE TO RELATED APPLICATIONS

This application is a non-provisional conversion of, and claims priority to, U.S. Provisional Patent Application No. 63/497,246, filed Apr. 20, 2023, which is incorporated by reference in its entirety.

### FIELD OF THE DISCLOSURE

Examples of the present disclosure generally relate to a lounge system for an internal cabin of an aircraft.

### BACKGROUND OF THE DISCLOSURE

Vehicles such as commercial aircraft are used to transport passengers between various locations. A typical aircraft includes an internal cabin having seats for passengers.

Narrow body airplanes are increasingly being used for long-haul flights. Accordingly, there is a desire for increased comfort and features equivalent to wide body airplanes, specifically within first and business class cabins. However, the reduced width of a narrow body aircraft (as compared to a wide body aircraft) presents spatial constraints that can limit the types of seating options therein.

### SUMMARY OF THE DISCLOSURE

A need exists for an area within an aircraft, such as a narrow body aircraft, which provides increased comfort and allows passengers to readily relax. Further, a need exists for a narrow body aircraft having a lounge area.

With those needs in mind, certain examples of the present disclosure provide a lounge system for an internal cabin of an aircraft. The lounge system includes a compartment bounded by a wall common to a monument, an interior outboard wall of the internal cabin, one or more side partition walls, and one or more end partition walls. One or more seats are within the compartment. One or more desks are within the compartment. One or more screens within the compartment. An egress area is also within the compartment.

In at least one example, the lounge system is disposed within the internal cabin, and the aircraft is a commercial passenger aircraft having a single aisle. In at least one example, the lounge system is disposed within the internal cabin proximate to a passenger door that allows passengers to enter and exit the aircraft.

In at least one example, the wall is a front wall of the lounge system, and a rear wall of the monument.

In at least one example, the one or more seats include a first seat and a second seat. The second seat can be coupled to (for example, directly connected to) the one or more end partition walls. The second seat can be configured to be oriented at an angle in relation to a longitudinal plane of the internal cabin. A lower luggage stowage area can be underneath the first seat.

In at least one example, an open overhead area is over the first seat. The open overhead area is devoid of an overhead stowage bin. The open overhead area extends above the egress area. Slots can be formed within a ceiling of the open overhead area. The slots are configured to allow for emission of light therethrough.

In at least one example, the one or more desks include a first desk and a second desk. The desks can be coupled to (for example, directly connected to) the interior outboard wall.

The one or more screens can be coupled to (for example, directly connected to) the interior outboard wall.

In at least one example, the one or more side partition walls include a first side partition wall separated from a second side partition wall by a threshold. The threshold leads into the egress area. One or more doors can be moveably coupled to one or both of the first side partition wall or the second side partition wall. The one or more doors are moveable between an open position in which the threshold is open, and a closed position in which the threshold is closed.

The compartment can include a windowless area and a window area.

One or more foot rests can be underneath the one or more desks.

Certain examples of the present disclosure provide an aircraft including an internal cabin, a monument within the internal cabin, and a lounge system within the internal cabin, as described herein.

Certain examples of the present disclosure provide a lounge system for an internal cabin of an aircraft. The lounge system includes a compartment bounded by a wall common to a monument, an interior outboard wall of the internal cabin, one or more side partition walls, and one or more end partition walls. One or more seats are within the compartment. An egress area is within the compartment. An open overhead area extends above the egress area. The open overhead area is devoid of an overhead stowage bin.

### BRIEF DESCRIPTION OF THE DRAWINGS

FIG. 1 illustrates a perspective front view of an aircraft, according to an example of the present disclosure.

FIG. 2 illustrates a perspective interior view of an internal cabin of an aircraft, according to an example of the present disclosure.

FIG. 3 illustrates a lateral view of a lounge system within an internal cabin, according to an example of the present disclosure.

FIG. 4 illustrates a perspective internal view of the lounge system of FIG. 3.

FIG. 5 illustrates a perspective internal first end view of the lounge system of FIG. 3.

FIG. 6 illustrates a perspective top view of the lounge system of FIG. 3.

FIG. 7 illustrates a perspective internal second end view of the lounge system of FIG. 3.

FIG. 8 illustrates a perspective internal view of the lounge system of FIG. 3 from the second end toward the first end.

FIG. 9 illustrates a perspective lateral end view of the lounge system.

FIG. 10 illustrates a perspective lateral view of the lounge system.

FIG. 11 illustrates a top view of the lounge system.

FIG. 12 illustrates a top plan view of an internal cabin of an aircraft, according to an example of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

Examples of the present disclosure provide a lounge system for an internal cabin of an aircraft, such as a narrow body, single aisle airplane. The lounge system includes a dual purpose seating arrangement having a front lounge seat area integrated with a front monument of the cabin, and a rear passenger seat sharing a common area with the front lounge seat area. In at least one example, the dual purpose seating arrangement also includes an egress area between a pair of slidable suite doors, and an overhead bin-less architecture above the egress area so a passenger can stand while entering the dual purpose seating arrangement.

The lounge system provides increased passenger comfort. The lounge system provides a front seating area seamlessly integrated with a front monument (such as a galley, lavatory, closet, or the like). In at least one example, the lounge system provides a luxury welcome area into the internal cabin. Optionally, the lounge system can be disposed at various other areas of the internal cabin.

Certain examples of the present disclosure provide an aircraft including an internal cabin, and a lounge system within the internal cabin. In at least one example, the lounge system is integrated with a monument within the internal cabin. The internal cabin can have a single aisle. In at least one example, the lounge system is devoid of a stowage bin above an egress area of the lounge system. In at least one example, the lounge system includes a front seat and a rear seat. The lounge system can include one or more desks. The lounge system can include one or more screens. The lounge system can include a windowless area and a window area.

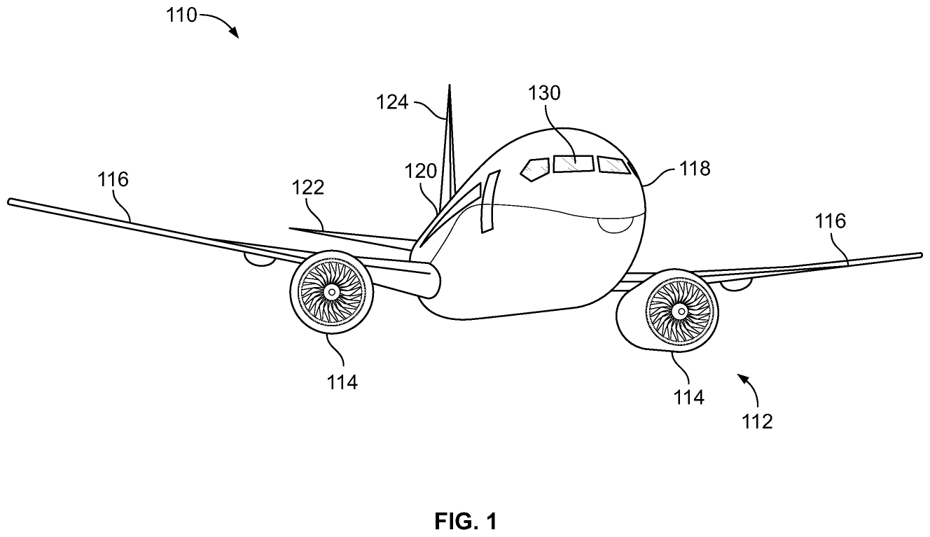

FIG. 1 illustrates a perspective front view of an aircraft 100, according to an example of the present disclosure. The aircraft 100 includes a propulsion system 112 that includes engines 114, for example. Optionally, the propulsion system 112 may include more engines 114 than shown. The engines 114 are carried by wings 116 of the aircraft 100. In other examples, the engines 114 may be carried by a fuselage 118 and/or an empennage 120. The empennage 120 may also support horizontal stabilizers 122 and a vertical stabilizer 124.

The fuselage 118 of the aircraft 100 defines an internal cabin 130, which includes a flight deck or cockpit, one or more work sections (for example, galleys, personnel carry-on baggage areas, and the like), one or more passenger sections (for example, first class, business class, and coach sections), one or more lavatories, and/or the like.

Alternatively, instead of an aircraft, examples of the present disclosure may be used with various other vehicles, such as automobiles, buses, locomotives and train cars, watercraft, and the like.

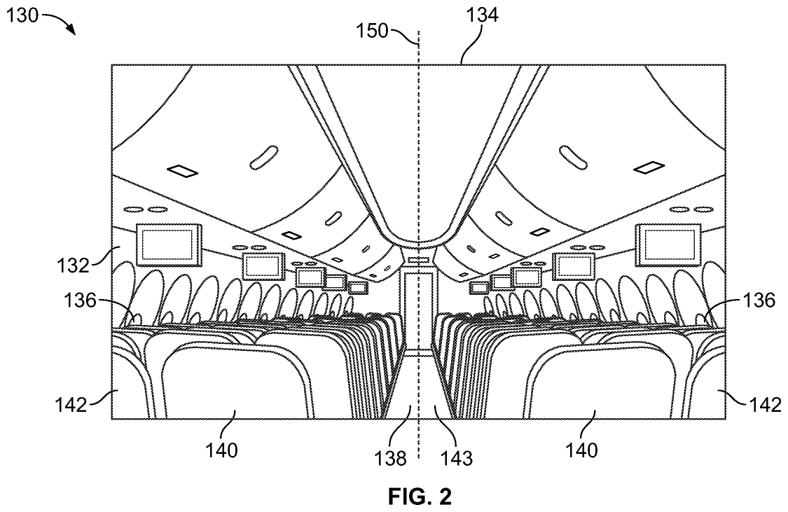

FIG. 2 illustrates a perspective interior view of an internal cabin 130 of an aircraft, according to an example of the present disclosure. The internal cabin 130 includes outboard walls 132 and a ceiling 134. Windows 136 may be formed within the outboard walls 132. A floor 138 supports rows of seats 140. As shown in FIG. 2, a row 142 may include three seats 140 on either side of an aisle 143. However, the row 142 may include more or fewer seats 140 than shown. Additionally, the internal cabin 130 may include more aisles than shown.

As used herein, the term “outboard” means a position that is further away from a central longitudinal plane 150 of the internal cabin 130 as compared to another component. The term “inboard” means a position that is closer to the central longitudinal plane 150 of the internal cabin 130 as compared to another component.

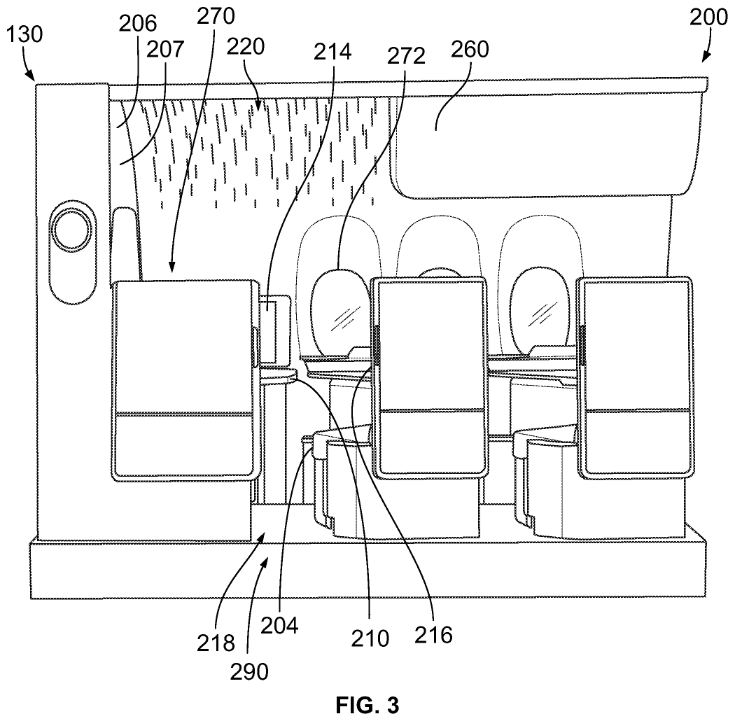

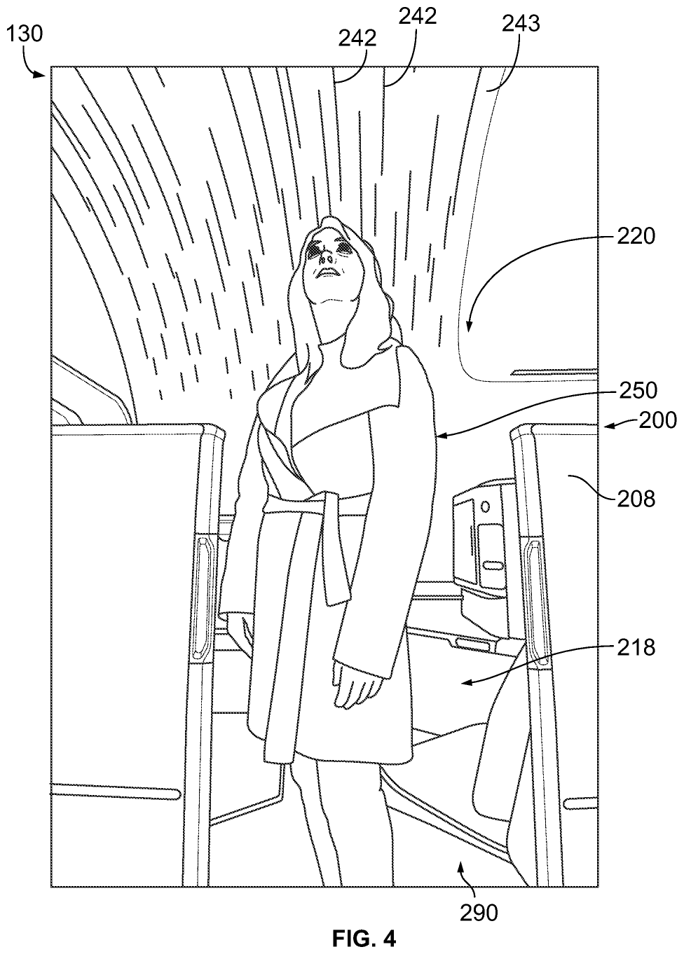

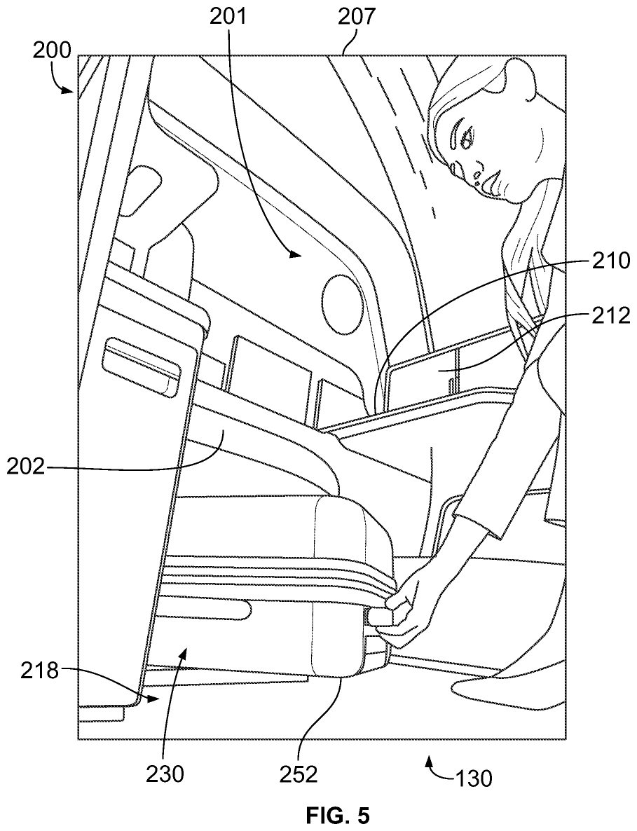

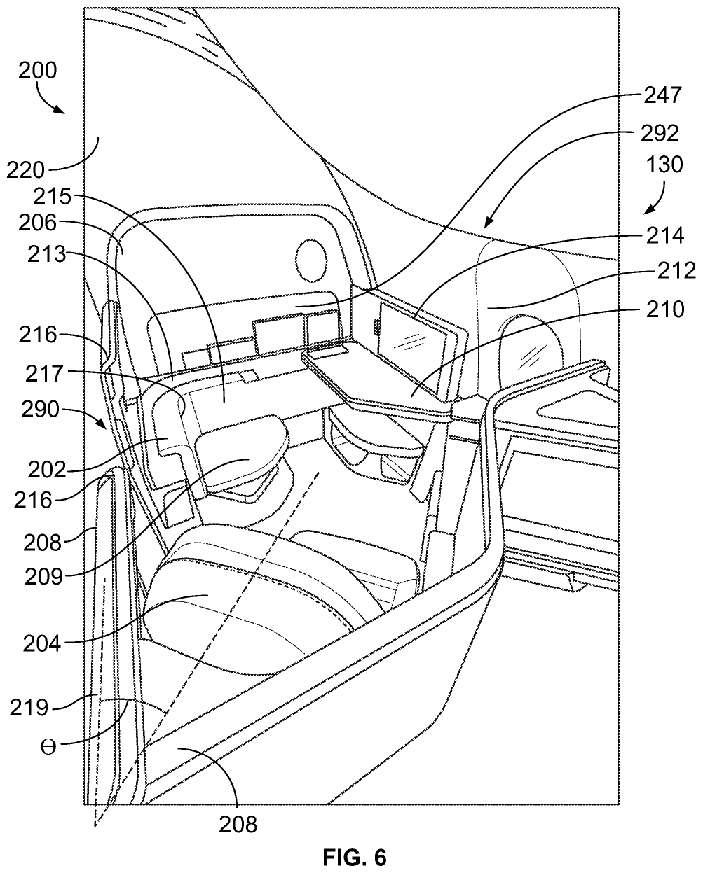

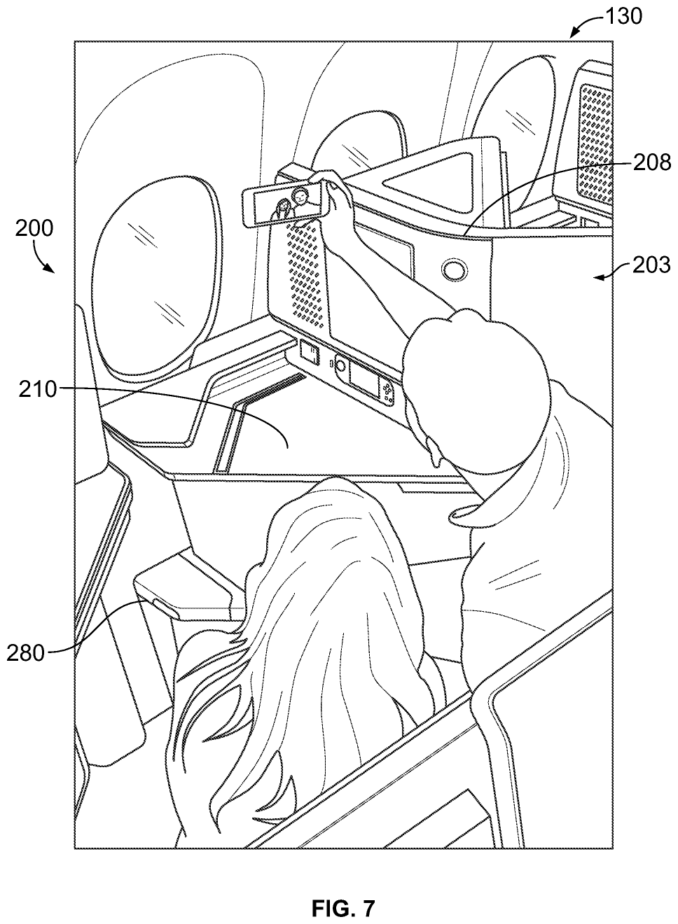

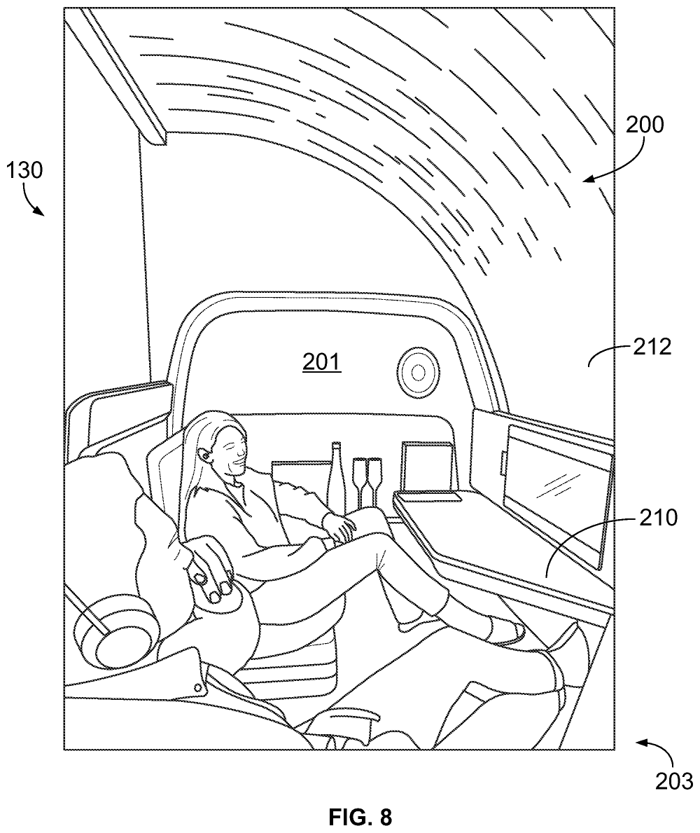

FIG. 3 illustrates a lateral view of a lounge system 200 within the internal cabin 130, according to an example of the present disclosure. FIG. 4 illustrates a perspective internal view of the lounge system 200 of FIG. 3. FIG. 5 illustrates a perspective internal first end 201 view of the lounge system 200 of FIG. 3. FIG. 6 illustrates a perspective top view of the lounge system 200 of FIG. 3. FIG. 7 illustrates a perspective internal second end view 203 of the lounge system 200 of FIG. 3. FIG. 8 illustrates a perspective internal view of the lounge system 200 of FIG. 3 from the second end 203 toward the first end 201.

Referring to FIGS. 3-8, the lounge system 200 includes one or more seats 202 and 204 within a compartment bounded by (for example, between) a monument 206 and one or more partition walls 208. The seat 202 is a first or front seat, and the seat 204 is a rear or second seat. Optionally, the seat 202 can be the second seat, and the seat 204 can be the first seat. The monument 206 can be a lavatory, a galley, a closet, or the like. In at least one example, the lounge system 200 is disposed within the internal cabin 130 of a narrow body, single aisle aircraft. In at least one example, the lounge system 200 is located at a front area of the internal cabin, such as proximate to a passenger door that allows passengers to enter and exit the aircraft.

The lounge system 200 can be integrated with the monument 206, which can be a galley, lavatory, closet, or the like. For example, a wall 207 of the lounge system 200 can be a wall of the monument. As a further example, the wall 207 can be a front wall of the lounge system 200, which also provides a rear wall of the monument 206. By integrating the lounge system 200 with the monument 206, space is saved within the internal cabin. That is, a single structure including the lounge system 200 and the monument 206 is provided. The single structure can be manufactured by a single provider. The single structure eliminates, minimizes, or otherwise reduces redundancy in structural features, and also reduces overall weight.

The lounge system 200 includes a compartment 292 bounded by the wall 207 (common to the monument 206—that is, the wall 207 can serve as a rear wall of the monument 206 and the front wall of the lounge system), an interior outboard wall 212 of the internal cabin 130, one or more side partition walls 208, and one or more end partition walls 208.

As shown in FIG. 6, in particular, the seat 202 can be disposed proximate to the monument 206. For example, the seat 202 includes a seat cushion 209 coupled to a backrest 211. The backrest 211 can include a front support 213 and a side support 215. The front support 213 can connect to the side support 215 via a curved support 217. The front support 213 can directly connect to the wall 207.

The seat 204 can be disposed proximate to one or more end walls 208, such as an aft dividing wall. As shown, the seat 202 is forward of the seat 204. The seat 204 is oriented at an angle θ in relation to a longitudinal plane 219 of the internal cabin 130. For example, the angle θ can be between 30-60 degrees. The angled nature of the seat 204 allows for increased clearance space for a path leading into the lounge system 200. In at least one example, the front lounge seat 202 is oriented orthogonal to the longitudinal plane 219.

In at least one example, the lounge system 200 also includes one or more desks 210, which can be coupled to an interior outboard wall 212. Optionally, the lounge system 200 may not include a desk.

In at least one example, one or more screens 214, such as electronic monitors, televisions, or the like, can also be disposed within the lounge system 200. For example, a screen 214 can be disposed above an outboard end of the desk 210, and coupled to the interior outboard wall 212. Optionally, the lounge system 200 may not include a screen.

In at least one example, the lounge system 200 also includes an egress area 218 connected to a threshold 290 between one or more slidable suite doors 216, which can be moveably coupled to one or more partition walls 208, for example. The threshold 290 can be an opening between two coplanar side partition walls. For example, a door 216 can be selectively moved between an open position, in which the egress area 218 is open, and a closed position, in which the egress area 218 is closed. The egress area 218 allows individuals to move into and out of the lounge system 200. The angled seat 204 provides increased area for the egress area 218.

In at least one example, the lounge system 200 also includes an open overhead area 220. The open overhead area 220 extends above the egress area 218. The open overhead area 220 above the egress area 218 allows a passenger 250 to stand while entering and exiting the lounge system 200.

As shown in FIG. 5, in at least one example, a lower luggage stowage area 230 is provided underneath the front seat 202 and forward of the egress area 218. The lower luggage stowage area 230 provides an area for luggage 252, in the absence of a stowage bin. The lower luggage stowage area 230 provides an easy roll-in/roll-out location for luggage (in contrast to an overhead stowage bin, which requires that luggage be lifted into and removed therefrom).

As shown in FIG. 4, in particular, the bin-less, overhead area 220 can be curved to follow a curvature of the fuselage. The overhead area 220 can include slots 242 for light to be emitted (such as by light emitting diodes) therethrough. That is, the slots 242 can be formed in the ceiling 243 that forms the overhead area 220.

As shown in FIG. 3, in particular, a portion of a front overhead bin 260 may be located above the seat 204, such as a rear seat. The overhead bin 260 does not extend over the seat 202, such as a front seat. The overhead bin 260 does not extend into the egress area 218.

In at least one example, the lounge system 200 includes a windowless area 270 and a window area 272. The windowless area 270 reduces light from entering therein, thereby allowing for the screen 214 to be situated laterally on top of the desk 210. The seat 202 can be in windowless area 270, while the seat 204 can be in the window area 272.

As shown in FIG. 7, one or more foot rests 280 can be provided, such as underneath a desk 210 coupled to a rear partition wall 208. A foot rest 280 can also be underneath the desk 210 (shown in FIGS. 5 and 6).

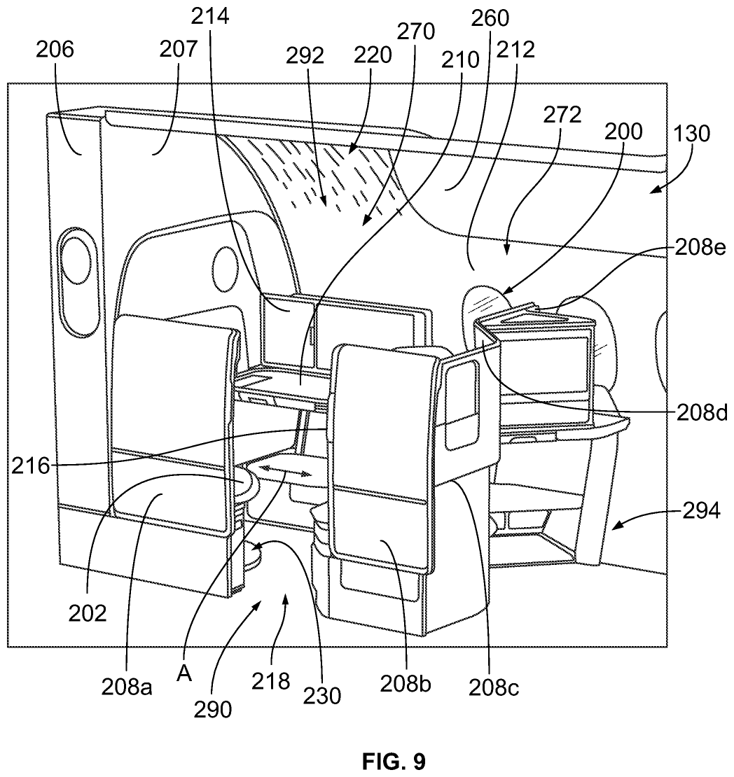

FIG. 9 illustrates a perspective lateral end view of the lounge system 200. As shown, the partition walls 208 includes side partition walls 208a and 208b separated by a threshold 290 that leads into the egress area 218. The door 216 can be slidably coupled to the partition wall 208b, and configured to slide in the directions of arrows A between an open position (shown in FIG. 9) and a closed position, in which the threshold 290 is closed. The partition walls 208a and 208b can be parallel with a longitudinal plane of the internal cabin 130.

The partition wall 208b connects to a rear partition wall 208c, which defines a portion of an aft end of the lounge system 200. The partition wall 208c can be perpendicular to the longitudinal plane of the internal cabin 130. As shown, the partition wall 208c can be an inboard partition wall that connects to a forward angled partition wall 208d, which, in turn, connects to a partition wall 208e that connects to the interior outboard wall 212. The partition walls 208c and 208e are in different planes, which are parallel to one another. The angled partition wall 208d is not parallel to the partition walls 208c and 208e. The angled partition wall 208 provides increased space for an area 294 behind the lounge system 200. The area 294 can be used for another lounge system, passenger seats, or the like.

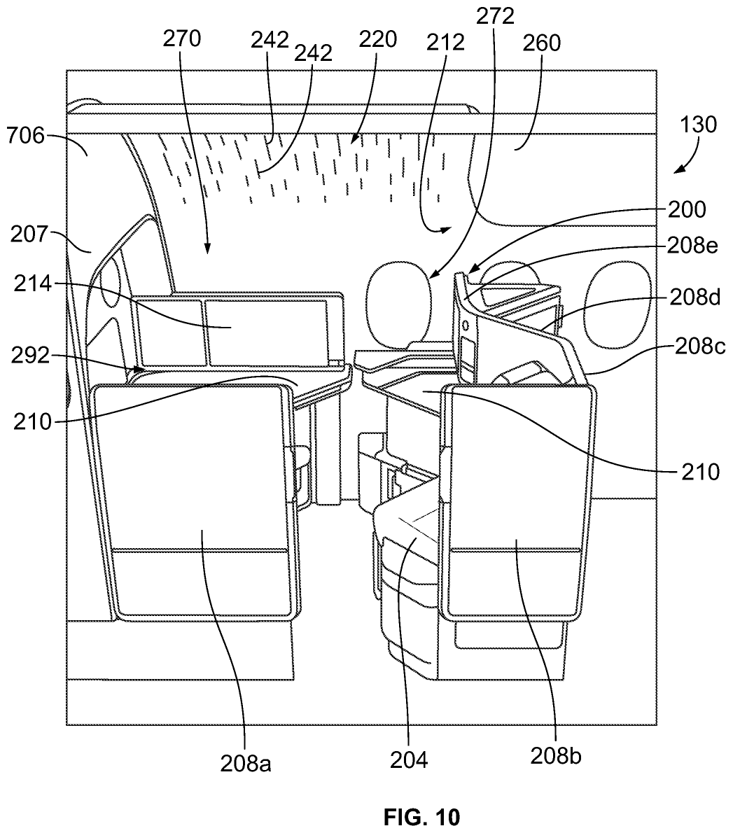

FIG. 10 illustrates a perspective lateral view of the lounge system 200. As shown, the overhead area 220 is curved to follow a curvature of the fuselage. The slots 242 are formed in the ceiling 243 that forms the overhead area 220. Optionally, the overhead area 220 may not include slots.

Referring to FIGS. 9 and 10, a portion of a front overhead bin 260 may be located above at least a portion of the seat 204. The overhead bin 260 does not extend over the seat 202. The overhead bin 260 does not extend into the egress area 218.

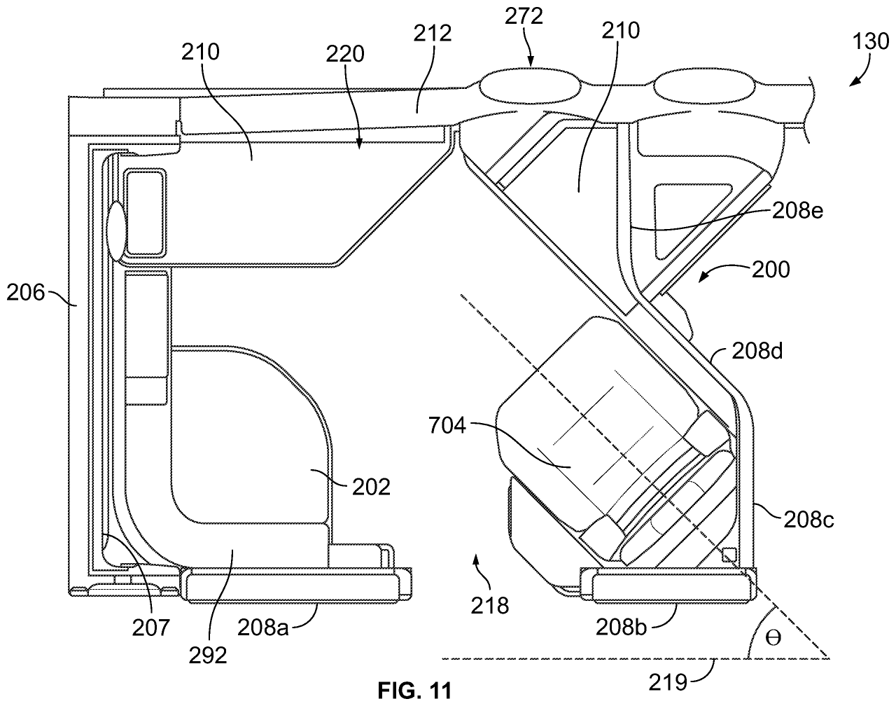

FIG. 11 illustrates a top view of the lounge system 200. As shown, the seat 204 connects to the partition walls 208c and 208d. The seat 204 is oriented at the angle θ in relation to the longitudinal plane 219 of the internal cabin 130. The angled nature of the seat 204 provides increased clearance space for the egress area 218.

Referring to FIGS. 9-11, the lounge system 200 includes a compartment 292 bounded by the wall 207 (common to the monument 206—that is, the wall 207 can serve as a rear wall of the monument 206 and the front wall of the lounge system), the interior outboard wall 212 of the internal cabin 130, the side partition walls 208a and 208b, and the end partition walls 208a, 208b, and 208c. The end partition walls 208a-c can include the angled wall 208b. Optionally, a single end partition wall can be used.

Referring to FIGS. 3-11, a passenger 250 entering the lounge system 200 notices an abundance of space. Upon entry, the passenger 250 may remain standing and gaze across the internal cabin. Overhead, the passenger can see light emitted through the slots 242 within the canopy, which has extra space due to the lack of an overhead stowage bin within the egress area 218.

The lounge system 200 can also include an in-suite minibar, library, and other such features, which can be within a space shared with the front monument 206 (such as a galley). The lounge system 200 provides versatile living space, allowing an individual to stretch out, sit at a desk, enjoy time with a companion, and/or have somewhere to sit if a main seat has been converted into a bed, for example.

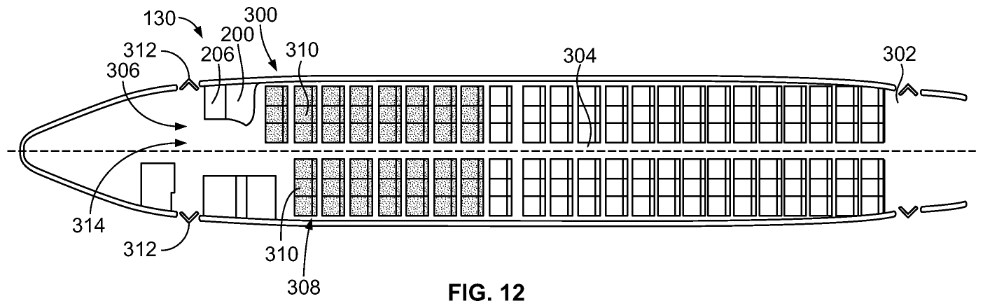

FIG. 12 illustrates a top plan view of an internal cabin 130 of an aircraft, according to an example of the present disclosure. The internal cabin 130 is within a fuselage of the aircraft. For example, one or more fuselage walls may define the internal cabin 130. The internal cabin 130 includes multiple areas, including a main cabin 300 having passenger seats, and an aft section 302 behind the main cabin 300. It is to be understood that the internal cabin 130 may include more or less areas than shown.

As shown, in at least one example, the internal cabin 130 includes a single aisle 304 that leads to the aft section 302. The single aisle 304 can extend through the center of the internal cabin 130. For example, the single aisle 304 can be coaxially aligned with a central longitudinal plane of the internal cabin 130.

The aircraft having the internal cabin 130 shown in FIG. 12 is a narrow body, single aisle aircraft. The aircraft is a commercial passenger aircraft, in contrast to a private aircraft. That is, the commercial passenger jet includes numerous seats for sale to the general public, in contrast to a private aircraft owned by an individual who restricts access to the private aircraft.

In at least one example, the lounge system 200 is located at a front area 306 of the internal cabin 130. The front area 306 can be in front of a first row 308 of passenger seats 310. As shown, the lounge system 200 can be proximate to a passenger door 312 that allows passengers to enter and exit the aircraft. For example, the lounge system 200 can be disposed between a cross-aisle 314 extending between doors 312, and the first row 308 of passenger seats 310. The lounge system 200 can be integrated with the monument 206, which can be a galley, lavatory, closet, or the like.

Optionally, the lounge system 200 can be located at other areas of the internal cabin 130, such as proximate to the aft section 302. Also, optionally, the lounge system 200 can be disposed in larger aircraft including more than a single aisle.

Further, the disclosure comprises examples according to the following clauses:

Clause 1. A lounge system for an internal cabin of an aircraft, the lounge system comprising:
a compartment bounded by a wall common to a monument, an interior outboard wall of the internal cabin, one or more side partition walls, and one or more end partition walls;
one or more seats within the compartment;
one or more desks within the compartment;
one or more screens within the compartment; and an egress area within the compartment.

Clause 2. The lounge system of Clause 1, wherein the lounge system is disposed within the internal cabin, and wherein the aircraft is a commercial passenger aircraft having a single aisle.

Clause 3. The lounge system of Clauses 1 or 2, wherein the lounge system is disposed within the internal cabin proximate to a passenger door that allows passengers to enter and exit the aircraft.

Clause 4. The lounge system of any of Clauses 1-3, wherein the wall is a front wall of the lounge system, and a rear wall of the monument.

Clause 5. The lounge system of any of Clauses 1-4, wherein the one or more seats comprise a first seat and a second seat.

Clause 6. The lounge system of Clause 5, wherein the second seat is coupled to the one or more end partition walls.

Clause 7. The lounge system of Clauses 5 or 6, wherein the second seat is configured to be oriented at an angle in relation to a longitudinal plane of the internal cabin.

Clause 8. The lounge system of any of Clauses 5-7, further comprising a lower luggage stowage area underneath the first seat.

Clause 9. The lounge system of any of Clauses 5-8, further comprising an open overhead area over the first seat, wherein the open overhead area is devoid of an overhead stowage bin, and wherein the open overhead area extends above the egress area.

Clause 10. The lounge system of Clause 9, wherein slots are formed within a ceiling of the open overhead area, wherein the slots are configured to allow for emission of light therethrough.

Clause 11. The lounge system of any of Clauses 1-10, wherein the one or more desks comprise a first desk and a second desk.

Clause 12. The lounge system of any of Clauses 1-11, wherein the one or more desks are coupled to the interior outboard wall.

Clause 13. The lounge system of any of Clauses 1-12, wherein the one or more screens are coupled to the interior outboard wall.

Clause 14. The lounge system of any of Clauses 1-13, wherein the one or more side partition walls comprise a first side partition wall separated from a second side partition wall by a threshold, wherein the threshold leads into the egress area.

Clause 15. The lounge system of any of Clauses 1-14, further comprising one or more doors moveably coupled to one or both of the first side partition wall or the second side partition wall, and wherein the one or more doors are moveable between an open position in which the threshold is open, and a closed position in which the threshold is closed.

Clause 16. The lounge system of any of Clauses 1-15, wherein the compartment comprises a windowless area and a window area.

Clause 17. The lounge system of any of Clauses 1-16, further comprising one or more foot rests underneath the one or more desks.

Clause 18. An aircraft comprising:
an internal cabin;
a monument within the internal cabin; and
a lounge system within the internal cabin, the lounge system comprising:
   a compartment bounded by a wall common to the monument, an interior outboard wall of the internal cabin, one or more side partition walls, and one or more end partition walls;
   a first seat and a second seat within the compartment, wherein the second seat is coupled to the one or more end partition walls, wherein the second seat is oriented at an angle in relation to a longitudinal plane of the internal cabin;
   a lower luggage stowage area underneath the first seat;
   an open overhead area over the first seat, wherein the open overhead area is devoid of an overhead stowage bin, and wherein slots are formed within a ceiling of the open overhead area, wherein the slots are configured to allow for emission of light therethrough;
   a first desk and a second desk within the compartment, wherein one or both of the first desk or the second desk is coupled to the interior outboard wall;
   one or more screens within the compartment, wherein the one or more screens are coupled to the interior outboard wall; and
   an egress area within the compartment, wherein the open overhead area extends above the egress area.

Clause 19. The aircraft of Clause 18, wherein the aircraft is a commercial passenger aircraft having a single aisle, and wherein the lounge system is proximate to a passenger door that allows passengers to enter and exit the commercial passenger aircraft.

Clause 20. The aircraft of Clauses 18 or 19, wherein the one or more side partition walls comprise a first side partition wall separated from a second side partition wall by a threshold, wherein the threshold leads into the egress area, wherein one or more doors are moveably coupled to one or both of the first side partition wall or the second side partition wall, and wherein the one or more doors are moveable between an open position in which the threshold is open, and a closed position in which the threshold is closed.

Clause 21. A lounge system for an internal cabin of an aircraft, the lounge system comprising:
a compartment bounded by a wall common to a monument, an interior outboard wall of the internal cabin, one or more side partition walls, and one or more end partition walls;
one or more seats within the compartment; and
an egress area within the compartment, wherein an open overhead area extends above the egress area, wherein the open overhead area is devoid of an overhead stowage bin.

As described herein, examples of the present disclosure provide an areas within aircraft, such as narrow body airplanes, that provide increased comfort for passengers, and allow the passengers to relax more readily. Further, examples of the present disclosure provide a lounge area within a narrow body commercial aircraft.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A lounge system for an internal cabin of an aircraft, the lounge system comprising:
a compartment bounded by a wall common to a monument, an interior outboard wall of the internal cabin, one or more side partition walls, and one or more end partition walls;
one or more seats within the compartment;
one or more desks within the compartment;
one or more screens within the compartment; and
an egress area within the compartment.

2. The lounge system of claim 1, wherein the lounge system is disposed within the internal cabin, and wherein the aircraft is a commercial passenger aircraft having a single aisle.

3. The lounge system of claim 1, wherein the lounge system is disposed within the internal cabin proximate to a passenger door that allows passengers to enter and exit the aircraft.

4. The lounge system of claim 1, wherein the wall is a front wall of the lounge system, and a rear wall of the monument.

5. The lounge system of claim 1, wherein the one or more seats comprise a first seat and a second seat.

6. The lounge system of claim 5, wherein the second seat is coupled to the one or more end partition walls.

7. The lounge system of claim 5, wherein the second seat is configured to be oriented at an angle in relation to a longitudinal plane of the internal cabin.

8. The lounge system of claim 5, further comprising a lower luggage stowage area underneath the first seat.

9. The lounge system of claim 5, further comprising an open overhead area over the first seat, wherein the open overhead area is devoid of an overhead stowage bin, and wherein the open overhead area extends above the egress area.

10. The lounge system of claim 9, wherein slots are formed within a ceiling of the open overhead area, wherein the slots are configured to allow for emission of light therethrough.

11. The lounge system of claim 1, wherein the one or more desks comprise a first desk and a second desk.

12. The lounge system of claim 1, wherein the one or more desks are coupled to the interior outboard wall.

13. The lounge system of claim 1, wherein the one or more screens are coupled to the interior outboard wall.

14. The lounge system of claim 1, wherein the one or more side partition walls comprise a first side partition wall separated from a second side partition wall by a threshold, wherein the threshold leads into the egress area.

15. The lounge system of claim 11, further comprising one or more doors moveably coupled to one or both of the first side partition wall or the second side partition wall, and wherein the one or more doors are moveable between an open position in which the threshold is open, and a closed position in which the threshold is closed.

16. The lounge system of claim 1, wherein the compartment comprises a windowless area and a window area.

17. The lounge system of claim 1, further comprising one or more foot rests underneath the one or more desks.

18. An aircraft comprising:
an internal cabin;
a monument within the internal cabin; and
a lounge system within the internal cabin, the lounge system comprising:
a compartment bounded by a wall common to the monument, an interior outboard wall of the internal cabin, one or more side partition walls, and one or more end partition walls;
a first seat and a second seat within the compartment, wherein the second seat is coupled to the one or more end partition walls, wherein the second seat is oriented at an angle in relation to a longitudinal plane of the internal cabin;
a lower luggage stowage area underneath the first seat;
an open overhead area over the first seat, wherein the open overhead area is devoid of an overhead stowage bin, and wherein slots are formed within a ceiling of the open overhead area, wherein the slots are configured to allow for emission of light therethrough;
a first desk and a second desk within the compartment, wherein one or both of the first desk or the second desk is coupled to the interior outboard wall;
one or more screens within the compartment, wherein the one or more screens are coupled to the interior outboard wall; and
an egress area within the compartment, wherein the open overhead area extends above the egress area.

19. The aircraft of claim 18, wherein the aircraft is a commercial passenger aircraft having a single aisle, and wherein the lounge system is proximate to a passenger door that allows passengers to enter and exit the commercial passenger aircraft.

20. The aircraft of claim 18, wherein the one or more side partition walls comprise a first side partition wall separated from a second side partition wall by a threshold, wherein the threshold leads into the egress area, wherein one or more doors are moveably coupled to one or both of the first side partition wall or the second side partition wall, and wherein the one or more doors are moveable between an open position in which the threshold is open, and a closed position in which the threshold is closed.

21. A lounge system for an internal cabin of an aircraft, the lounge system comprising:
a compartment bounded by a wall common to a monument, an interior outboard wall of the internal cabin, one or more side partition walls, and one or more end partition walls;
one or more seats within the compartment; and
an egress area within the compartment, wherein an open overhead area extends above the egress area, wherein the open overhead area is devoid of an overhead stowage bin.
